(19) United States
(12) Patent Application Publication
(10) Pub. No.: US 2009/0270832 A1
(43) Pub. Date: Oct. 29, 2009

(54) NEEDLELESS PORT ASSEMBLY FOR A CONTAINER

(75) Inventors: Joost M. Vancaillie, Lombise (BE); Georges Rondeau, Braffe (BE); Bernardus Johannes Geling, Kessel-Lo (Leuven) (BE); Gianni Di Stefani, Ath (BE); Eric J. Henaut, Arquennes (BE)

Correspondence Address: K&L Gates LLP, P.O. Box 1135, Chicago, IL, 60690-1135, US

(73) Assignees: BAXTER INTERNATIONAL INC., DEERFIELD, IL (US); BAXTER HEALTHCARE S.A., ZURICH (CH)

(21) Appl. No.: 12/108,127

(22) Filed: Apr. 23, 2008

(51) Int. Cl. A61J 1/14; A61J 1/10

(52) U.S. Cl. 604/408; 604/414

(57) ABSTRACT

A needleless access port is assembled from parts sealed to a flexible container, such as a container for intravenous infusion, parenteral nutrition or transfusion. The port includes a lower housing for sealing to the container, the lower housing having an upright tower for mounting an upper housing. The upper housing has at least one connector or valve and a sleeve for mounting to the tower. The sleeve includes connectors so the upper housing can be mounted in a first, upper resting position, and a second lower, active position, for adding liquid to the container or for removing liquid from the container. Even after assembly to a container, the upper housing may be removed and the lower housing may be used instead with a standard IV spike set.

### BACKGROUND

The field of the invention relates generally to systems and connectors for allowing selective fluid communication with fluid containers, such as medication or medical fluid containers. The invention relates particularly to connectors and ports that allow for a first, receiving port for receiving a medicant fluid for mixing with a liquid within the medical fluid container and a second, administration port for delivery of the combined medicant and liquid or to a port which provides reception and delivery of fluids.

Medical solutions are provided in containers of several different constructions. For many years and even today solutions were provided in rigid containers such as glass containers. Other containers are not rigid but exhibit varying degrees of flexibility. These containers include blow molded containers which may be constructed of plastics including high density polyethylene. Containers made out of films form another type of flexible or non-rigid containers. Such containers or bags are typically formed of two flexible sheets or films of material joined at their peripheral edges by well-known methods, such as ultrasonic, heat, radiofrequency (RF), or laser sealing.

Containers for medical solutions may contain one or more ports to allow the administration of a preferred solution to a patient. For example, the container may include a separate medication or injection and administration port. The medication port allows a fluid to be added to the contents of the container while maintaining the sterility of the container. The administration port allows connection of the container to an administration set so that the contents may be provided to a patient.

In flexible containers, the containers include separate fill and administration ports which extend through a wall or seam of the bag. More specifically, such ports typically include plastic tubular members bonded within the peripheral seal, which allow for communication between an interior of the bag and the exterior. The tubular members are temporarily sealed by any of a number of conventional sealing devices, such as a pierceable diaphragm, elastomeric septums or frangible cannula, which are also all well known to those skilled in the medical fluid container field.

As noted above it is often desired in infusion therapy to mix a medication with the contents of a medical fluid container to dilute a medicament for administration to a patient. These medications are frequently provided in a glass vial or prefilled syringes. From time to time herein, the terms “vial,” “vial connection port,” and other uses of the word “vial” will be used in reference to a medical container, but it should be understood that embodiments of the present invention are not limited to use with a glass vial, but can be applied to any medicant container which includes a connection system which allows access and withdrawal of the contents of the container for introduction to the flexible medical fluid container or for withdrawal from the flexible medical fluid container.

If the medicant in the vial is provided as a liquid it may be withdrawn from the vial and added directly to the solution in a flexible medical fluid container for subsequent administration to a patient. In other applications, the contents may be lyophilized and must be reconstituted before withdrawal from the vial. Syringes with either needles or vial-piercing cannulas are utilized to access and withdraw the contents of the container.

It is desirable to allow the addition and withdrawal offluids to a container, such as a flexible bag, without using a needle. Present day containers typically have a medication port with a solid rubber septum that is pierced by a needle to allow access to the content. Such needles can cause needle sticks to caregivers and medical professionals, and can also cause leaks in the ports. Withdrawal is generally accomplished with a spike which forms a component of an administration set. Thus, it would be desirable to penetrate a port without having to use a needle or a spike. Variations of the previous art are illustrated in U.S. Pat. No. 4,410,321; U.S. Pat. No. 4,411,662; U.S. Pat. No. 4,432,755; U.S. Pat. No. 4,583,971; U.S. Pat. No. 4,606,734; U.S. Pat. No. 4,936,841; U.S. Pat. No. 5,308,347; U.S. Pat. No. 5,352,191; U.S. Pat. No. 5,364,386; and U.S. Pat. No. 5,826,713; and U.S. Pat. Appl. Publ. 2007/0299419, each being hereby incorporated herein by reference.

As set forth in more detail below, the present invention provides an improved port system for medicant mixing or administration with several aspects that may be employed separately or together to address one or more of the above drawbacks of prior containers and systems.

### SUMMARY

There are many embodiments of the invention. A first embodiment is a needleless access port. The needleless access port includes a base with a tower and a sealing area for sealing to a flexible bag, a sealing membrane within the base, an access portion moveably assembled to the base, the access portion including at least one seat and a spike. The needleless access port also includes a seal between the spike and the tower, wherein the access portion is configured for mounting to the tower in a first inactivated configuration and in a second activated configuration, and wherein the seal between the tower and the spike is maintained in the first and second configurations and during a transition between the first and second transitions, and wherein the sealing membrane is configured for piercing by the spike when the access portion is moved to the second configuration, and a cap covering the access portion.

Another embodiment is a needleless access port. The needleless accesss port includes a base with a sealing area, a prominent tower integrally joined with the base, the tower further including a step, and a sealing membrane within the base, and a housing slidably and sealingly mounted to the base, the housing including an outer sleeve and further including two mounting seats and at least one inner tab for mounting to the tower in a first configuration and a second inner tab for mounting to the tower in a second configuration. The needleless access port also includes a spike on an inside of the housing, the spike configured to pierce the sealing membrane when the housing is moved to the second configuration.

Another embodiment is a needleless access port. The needleless access port includes a base housing having a generally cylindrical tower, an area for sealing to a container, and a sealing membrane isolating the tower from the area for sealing. The needleless access port also includes a top housing including an inner spike for slidably mounting to the cylindrical tower, the top housing also including an integrally mounted outer sleeve, at least one connector mounted to the top housing; and it also includes a cap mounted over the top housing, wherein the top housing is configured for mounting to the base housing in two configurations, a first inactivated configuration and a second activated configuration, and wherein a seal between the top housing and the base housing is maintained in the first and second configurations and during a transition between the first and second configurations.

Another embodiment is a needleless access port. The needleless access port includes a plunger with an inner spike, an outer sleeve, and a top mounting seat. The needleless access port also includes a cap mounted over the plunger, and a base for sealing to a container, the base including an area for sealing to the container, an inner sealing membrane, and an outer surface for sealing to the plunger or the cap, wherein the base includes a prominent generally cylindrical tower integrally mounted to the base for interfacing with the spike, and wherein the plunger is configured for mounting to the base in a first inactivated position and in a second activated position, and wherein a seal is maintained between the outer surface and the plunger or the cap in the first and second positions and during a transition between the first and second positions.

Another embodiment is a needleless access port. The needleless access port includes a plunger including a spike, an outer sleeve, and a mount for a valve, and a cap configured for mounting over the plunger. The needleless access port also includes a base including an area for sealing to a connector, a membrane seal, a first tower for accepting the spike, a second tower for mounting to the plunger, and an outer surface for sealing to the cap, wherein the plunger and the base are configured for assembly in a first inactive position and for use in a second activated position, wherein the spike is maintained with the first tower in the first and second positions, and wherein a seal is maintained between the cap and the outer surface for sealing to the cap in the first and second positions.

Additional features and advantages are described herein, and will be apparent from, the following Detailed Description and the figures.

### BRIEF DESCRIPTION OF THE FIGURES

FIG. 1 is a perspective view of a flexible container and a first embodiment of the needless access port;

FIG. 2 is a partial cross-section view of the needleless access port;

FIG. 3 is a close-up of a portion of FIG. 2 showing greater detail;

FIG. 4 is a bottom perspective view of the embodiment of FIG. 1;

FIG. 5 is a perspective view of a two-port embodiment;

FIGS. 6-8 present another embodiment, in which a user pushes a cap to activate and use the needleless port; and

FIGS. 9-11 present another embodiment, in which a user turns a cap to activate and use the needleless port.

### DETAILED DESCRIPTION

Embodiments allow medical professionals and care givers to add medicine or other liquid or fluid to a container without using needles. These same embodiments also allow withdrawal of the liquid in the container without using needles. As described below, container embodiments may have one port or more than one port. Single port embodiments may have one needleless access valve or more than one. A wide variety of embodiments are possible, of which only a few are discussed herein.

### Two-Valve Embodiment

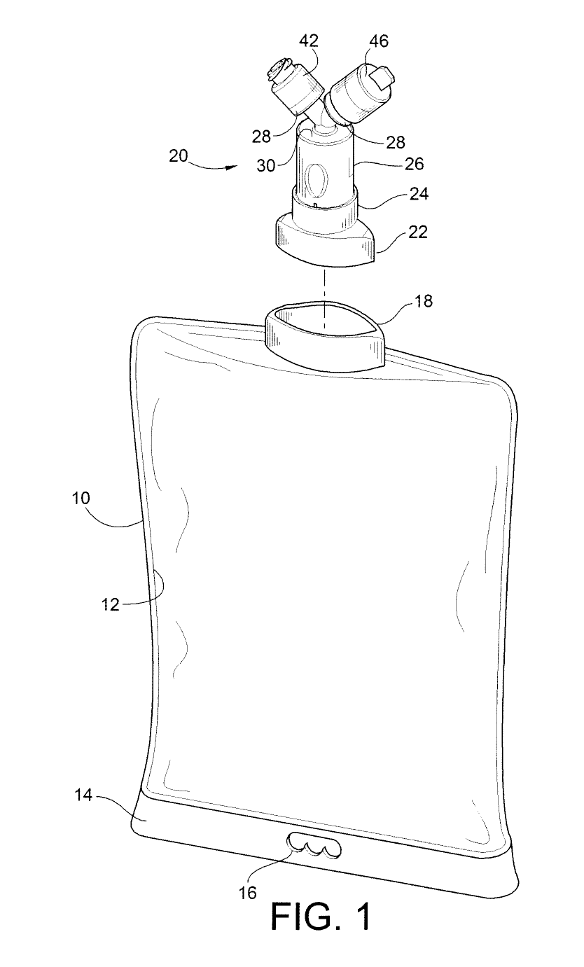

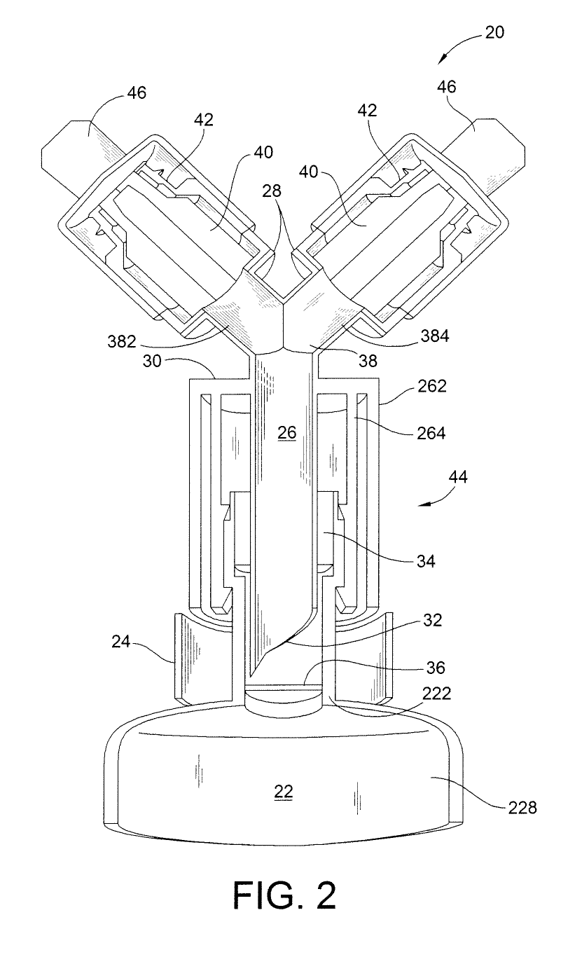

In a first embodiment, disclosed in FIGS. 1-2, a flexible container 10 is configured for assembly to a needleless access port 20, the needleless access port includes two valve seats or areas 28 for mounting valves 40, one valve shown with a protective cap 42. The container 10 is made from at least one layer of plastic, such as PVC or other plastic, such as polyolefin, polyethylene, or layers of plastics. Some embodiments are made with two layers or plies of film. Container 10 includes a central hollow area or internal portion 12 to be filled with liquid, and also includes sealed edges 14, a mounting area 16, and a sealing area 18. Sealing area 18 may be reinforced as shown, or may simply include shaped areas of the layer or layers of plastic.

In one manner of assembly, a lower housing portion 22 of the port 20 is inserted through an opening 18 in an edge 14 of container or bag 10, such that the opening 18 of the bag 10 overlies the lower housing portion 22 of the port structure 20. Port 20 is bonded to the opening 18 using known methods, such as heat sealing, radiofrequency, ultrasonic or laser welding. Plastic welding or solvent bonding may also be used. When the opening 18 is sealed to the port 20, an interior chamber 12 of the unitary container 10 is defined by the flexible bag portion 10 and port 20. The illustrated container has a single chamber 12 or compartment, but it is contemplated that embodiments may include containers having a plurality of interior chambers or compartments.

The needleless access port 20 includes a lower housing 22, as noted, intended for assembly to sealing area 18 of the container 10. A portion of lower housing 22 is in the general form of a three-dimensional ellipse. Other embodiments may have a circular cross-section or other desired shape. The port 20 includes a generally cylindrical upper housing 26 that also includes the circular areas or seats 28 for valves 40, with a luer valve cap 42, shown with protective caps 46. Upper housing 26 also includes a transverse top section 30 and a tamper-evident ring 24, the tamper-evident ring intended for breaking-off before use of the needleless access port 20.

A closer view of the components is seen in FIG. 2. Needleless access port 20 lower housing 22 includes an integrally-formed tower 222 and a base portion 228. Upper housing 26 includes an outer sleeve 262 and an inner sleeve 264. Tower 222 protrudes prominently from the base 22. Outer shroud 262 has a cross section in the general shape of a circle. Inner shroud 264 may have a cross section in the general shape of a circle, but some embodiments use only two arcs of a circle, several degrees wide. A sleeve is meant in the sense of an open-ended flat or tubular cover for the lower housing. An arc portion will, of course, not be perfectly flat. Above a spike 32 and the outer and inner shrouds 262, 264, the upper housing 26 assumes a Y-shape 38 and splits into two portions 382, 384, each portion having a valve seat 28 for a needleless valve 40. In other embodiments, there may be connectors, such as luer connectors, or any other desired connectors, rather than the valves.

Needleless access port 20 also includes the spike 32 that is integrally molded to the upper housing 26, e.g., by injection molding. Other embodiments may use a spike 32 that is assembled or attached to the upper housing 26. The spike 32 also has a cross section that is generally in the shape of a circle. The needleless access port 20 includes a seal or membrane 36 that isolates the tower 222 from the lower portion 228 of lower housing 22, i.e., the seal 36 seals the fluid in the container 10. Needleless access port 20 includes a sleeve 34, which acts as a sliding seal and a friction member, allowing sliding movement of spike 32, which is connected to the upper housing 26, with respect to tower 222, which is connected to lower housing 22. Sleeve 34, which may be an elastomer or a thermoplastic elastomer (TPE), also acts to somewhat impede or dampen movement of spike 32 and thus upper housing 26. Inner shroud 264 and tower 222 act as a catch and latch system 44, in which the upper housing 26 is caught and latched by features on its inner sleeve 264 interacting with features on the tower 222.

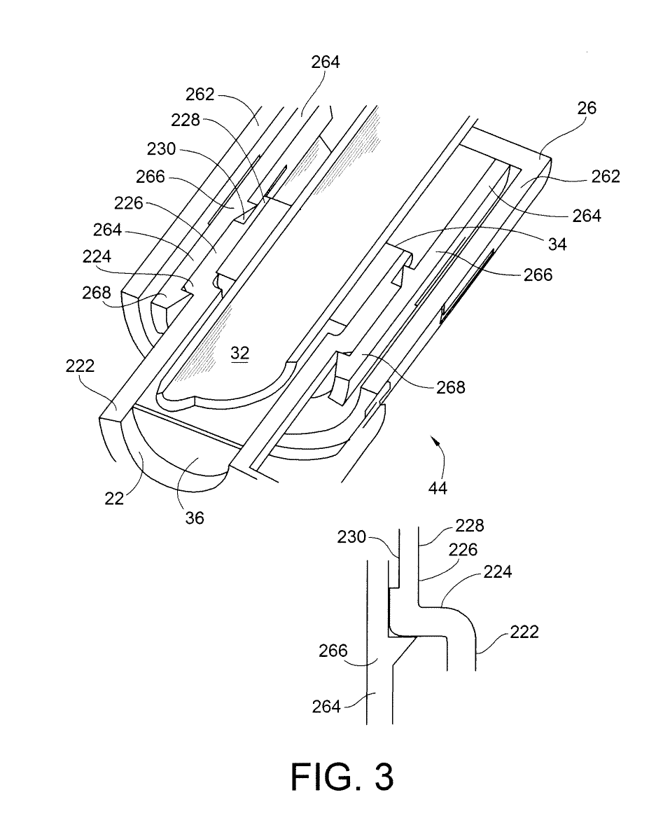

A closer look at the components of the needleless access port 20 is taken in FIG. 3. In FIG. 3, the upper housing 26 is shown in the same position as in FIG. 2, a resting position in which the spike 32 has not been lowered to penetrate seal or membrane 36. Lower housing 22 with tower portion 222 is seen to include an abrupt angle or transverse portion 224, followed by a further longitudinal portion 226, and a thinner terminal upper portion 228 with a notch 230. The transverse portion 224 is a step between the lower portion of tower 222 and the terminal portion 228.

As best seen in the left portion of FIG. 3, inner shroud 264 includes an upper male snap fit connection 266, followed by a lower male snap fit connection 268. Shown for context is outer shroud 262. The upper male snap fit 266 fits into the notch 230 of the thinner portion 228 of tower 222, while lower male snap fit 268 fits into the transverse portion 224 of tower 222. Thus, the transverse portion 224 is seen to act as a female snap fit connection with male snap fit 268. These snap fit connections are seen to comprise catch and latch system 44, in which the upper housing 26 is controllably moved and held with respect to lower housing 22. Male snap fit 268 is in effect a tab which fits into the slot formed below step 224 of tower 222. While the snap fit connections described herein are particularized as male or female, it is understood that with proper design, the two could be reversed, with male snap fits on the tower 222 and female snap fits on the inner shroud or shrouds 264. It will also be recognized that other fits may be used, such as tabs and slots, and the like.

In one embodiment, the catch and latch system 44 prevents removal of the inner shroud 264 and upper housing 26 from lower housing 22. In another embodiment, the transverse portion 224 and lower male snap fit 268 are gently angled so that lower snap fit 268 may be removed from transverse portion 224 by an upward movement, thus removing inner shroud 264 and upper housing 26 from lower housing 22. With the upper housing removed, the lower housing, with tower 222 and membrane 36 remain. In this embodiment, a standard IV spike head, as seen in U.S. Pat. Appl. Publ. 2007/0299419, may be used instead. With only lower housing 22, tower 222, and seal 36 remaining, only seal 36 prevents access to the medication. Thus, a standard IV spike head, or even a needle, may be used to piece seal 36 and access the contents within the container. The diameter of seal 36 may be sufficiently large, from 5.5 mm to about 25 mm, to allow penetration of a variety of standard IV spikes or even needles.

In this application, as noted, a user is typically not trying to move the upper housing upward against the snap fits 224, 268 to remove the upper housing 26 from the lower housing 22. FIG. 3 depicts the resting or inactive position before the upper housing 26 is pressed in a downward motion so that spike 32 pierces seal 36 and allows fluid communication between the container internal portion 12 and the valves 40. Male snap fit 268 does not restrain female snap fit 224 from a downward motion. Instead, the notched area near terminal length 228 of tower 222 restrains male snap fit 266 from downward movement. As discussed below, a tamper-evident ring and its frangible attachment to upper housing 26 also restrain lower movement of the housing. Sleeve 34, on the inside of tower 222 and between tower 222 and spike 32, acts as a friction fit between tower 222 and spike 32 to restrain movement, as well as a seal. It will be recognized that a seal between the tower 222 and the spike 26 may be accomplished in other ways, e.g., one or more O-rings in appropriate grooves on the outside of spike 26 and the inside of tower 222.

When a user wishes to access internal portion 12 with needleless access port 20, the user presses downward on any part or component of upper housing 26. As shown in the FIG. 3 inset, this causes male snap fit 266 to move downward from notch 230 and terminal portion 228 until the female snap fit connection 224 is reached. At this point, the spike 32 will have pierced the membrane 36, allowing fluid communication between the container 10 and the valves 40. Male snap fit 266 will be caught on female snap fit 224. It will be recognized by those having skill in the art that the angles of the male and female portions of the snap fit connections determine whether the connection is permanent or whether the connection can be reversed. In general, connections using right angles or angles near 90° cannot be reversed, while connections made with gentle sloping angles are easily reversed, i.e., with gentle angles the spike 32 can be removed from the membrane 36 and upper snap fit 266 restored to its position in notch 230.

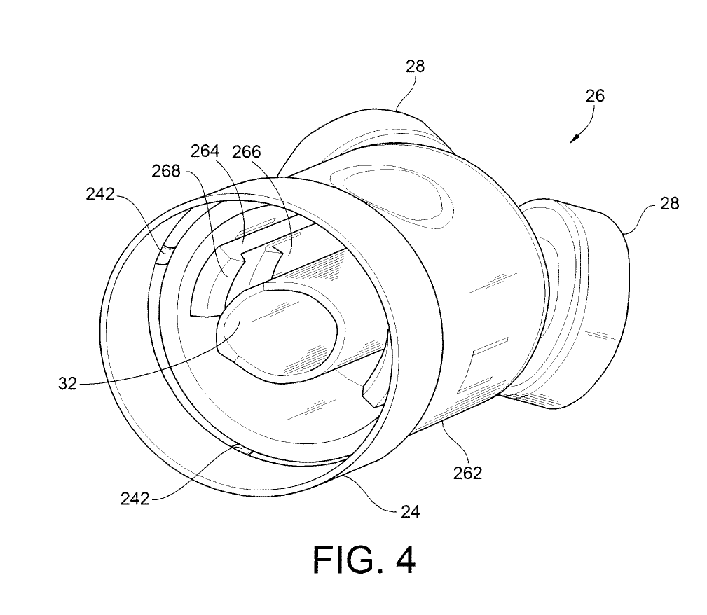

FIG. 4 depicts another view of the needleless access port upper housing 26, from the bottom. In this view, the sealing membrane is removed so that the internal portions may be seen with greater clarity. The central spike 32 is concentric with the upper housing 26 and with the outer shroud 262. Inner shroud 264 need not be continuous, but may include, as shown, only two arc segments with upper 266 and lower 268 snap fit connections for mating with the lower housing, which is not shown in this view. The arc segments need not extend far, only far enough so that the needleless access port is securely held to the container during use. For example, arc segments of about 10 degrees to about 150 degrees may be used.

Tamper-evident ring 24 is seen to be attached to the upper housing 26 with a plurality of thin frangible connections 242, in this instance four such connections at 90° around the periphery of the ring. Other embodiments may use a different configuration or a different number of such connections. Of course, the tamper-evident ring 24 or seal need not encompass the entire circumference of the upper housing 26, it needs only cover a portion sufficient to prevent usage of the access port 20 without removing the ring or seal. Thus, a partial ring or even several tabs attached in a frangible or breakable manner are sufficient to serve as a tamper-evident seal or barrier to use. Upper housing 26 is also made with two circular seats or areas 28 for attachment of connectors or valves after the upper housing itself has been manufactured.

The materials used for the needleless access port, and its components, are primarily plastics. The port should be sufficiently rigid for ease and surety of handling by medical professionals and caregivers. Some embodiments are made from high density polyethylene (HDPE), which is sterilizable and economical. Other embodiments may be made from other olefins, olefin blends such as polyoctene-ethylene, polycarbonate, cyclic-olefin-copolymers (COCs) and other medically-acceptable polymers. Plastics with a Young's modulus of at least 1000 MPa have worked well. Of course, the needleless access port should be sterilized such as with γ-ray sterilization or β ray sterilization before it is permanently assembled to the container. Other techniques may be used. Sleeve 34 may be made from a medically-acceptable elastomer or thermoplastic elastomer (TPE), to seal between the surfaces of the tower 222 and the spike 32. The membrane 36 may be made of a thin plastic, or may be made from an elastomer, such as silicone or other material that is penetrated by the spike 32 without leaving shards or particulates.

The tamper-evident ring is molded to the outer shroud, as noted, by one or more thin sections which are easily broken, i.e., frangible. This ring provides an additional reason for using reasonably rigid materials, since relatively rigid or brittle thin sections can be broken off with reasonably small amounts of force, rather than a plastic which is tougher or more extensible and does not break as easily. While four thin frangible sections at 90° are used in one embodiment, more segments or fewer may be used, e.g., two sections at 180° or 3 sections at 120°, or 6 or 8 sections with appropriate separation to ensure full coverage. The force required to break off the ring is adjusted by tailoring the cross-sectional area of each section and the number of sections. In the present design, the ring is not removed from the port once the frangible sections are broken, the ring remains since its outer diameter is less than that of the upper portion and the valves. In other designs, the ring itself has a perforated section along its height. The perforations may be broken and the ring then completely removed.

It will be recognized that the upper housing and lower housing of the needleless access port are not necessarily molded as single parts. For example, the membrane 36 of the lower housing in some embodiments is made from an elastomer, although in some embodiments a thin section of plastic may be used. The upper housing, however, is far too complicated for manufacture or molding as a single component with a single tool. Thus, the components of the upper housing, in one embodiment, are first molded and then assembled in an integral manner. An integral assembly is an assembly which cannot be reversed without destroying the molded or assembled object.

For example, the portion of the upper housing that includes valve seats 28, Y-section 38, and internal spike 32 may be molded or formed integrally as a single piece. The inner sleeve may be molded, extruded, or formed as one or more pieces. The outer shroud 262 and top portion 30 may be molded with the frangible ring. The several pieces may then be assembled to form an integral assembly, including the upper housing, the inner shroud or shrouds, and the spike. Assembly may be accomplished with any medically-acceptable assembly technique, such as heat sealing, radiofrequency, ultrasonic or laser welding. Plastic welding or solvent bonding may also be used. The valves themselves, or a single valve, may be sonic welded onto the plunger or other component to which one or more valves mount. Other techniques may also be used. In other embodiments, other techniques and other molding and assembly methods may be used. The assembly should insure that the assembled parts are strong, leak-free and sterilized or sterilizable.

### Two-Port Embodiment

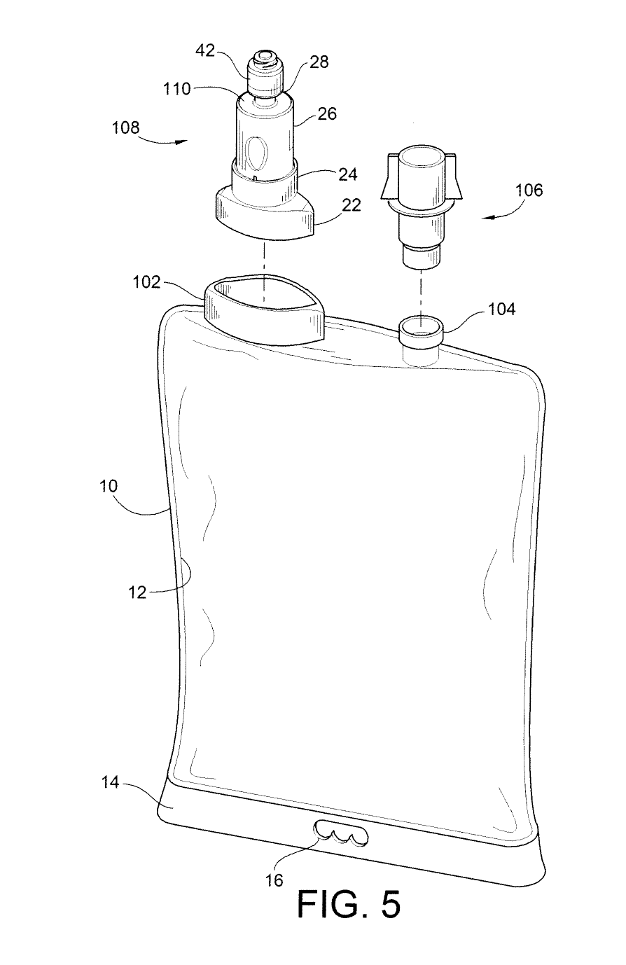

Another embodiment demonstrates that two separate ports may be used with flexible containers. In the embodiment of FIG. 5, a flexible container 10 is configured for assembly to a needleless access port 108, the needleless access port including a valve seat 28 for mounting a luer valve cap 42 with a protective cap (not shown). Container 10 includes a central hollow area or internal portion 12 to be filled with liquid, and also includes sealed edges 14, a mounting area 16, and two sealing areas 102, 104 for mounting ports 106, 108. First sealing area 102 is designed with a generally ovate shape, for mounting a needleless access port 108. Needleless access port 108 includes a base 22, a tamper evident ring 24, an upper housing 26, and a valve seat 28. The internals of the access port 108 are identical to those of access port 20, except that provision is made for only a single valve seat 110 and valve 28. Sealing area 104 is designed and configured for assembly of port 106. Port 106 is designed for conventional use with a standard IV spike head, as disclosed in U.S. Pat. Appl. Publ. 2007/0299419.

### Push-to-Activate Embodiment

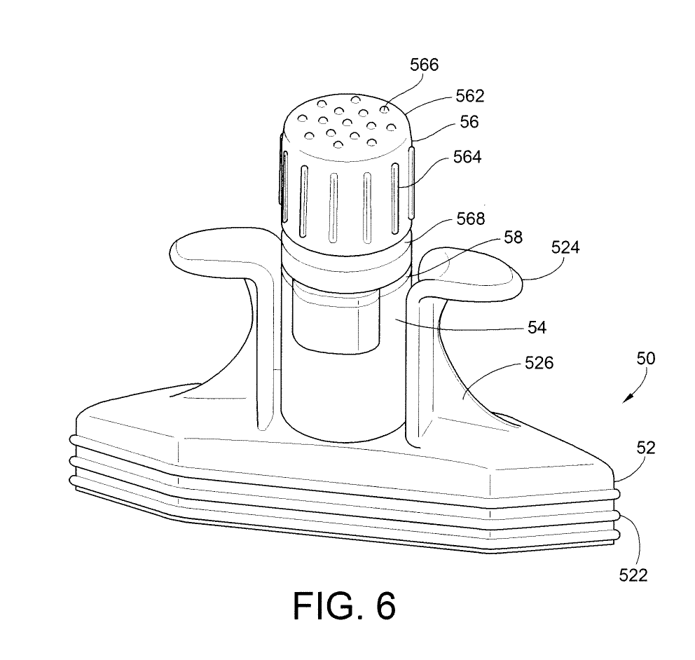

There are other embodiments of a needleless port for access and infusion. A second embodiment of a needleless port 50 is presented in FIGS. 6-8. This is a needleless push-to-activate port 50. The port 50 includes a base or gondola 52 with ribs 522 for welding or sealing to a container of liquid (not shown). The base 52 also includes grasping fingers 524 whose assembly to base 52 is reinforced with gussets 526. Base 52 supports a tamper-evident ring 54 and, visible in FIG. 6, a cap 56. Cap 56 mounts to a plunger 58 (barely visible in FIG. 6), and includes a lower portion 568 and an upper portion 562. Upper portion 562 includes a plurality of vertical ribs 564 for gripping by a user, and a plurality of nubs or raised surfaces 566, for tactile feeling by a user.

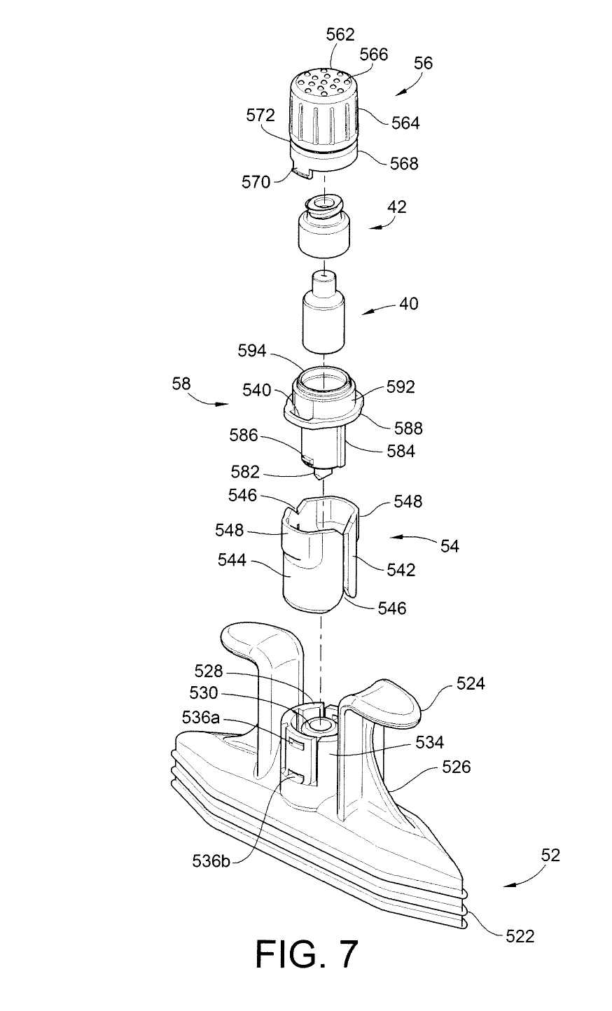

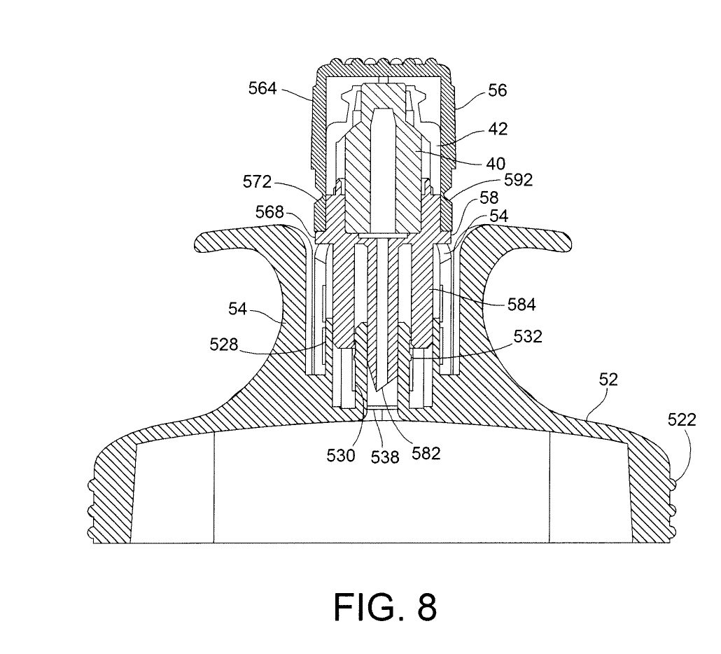

As better shown in the exploded view of FIG. 7, base or gondola 52 also includes an inner tower 530, in the form of a one-piece, hollow cylinder, and an outer cylinder or ring 528 in four sections 534 as shown. Two of the sections 534 of outer ring 528 have orifices 536a and 536b that act as female snap fits to capture male snap fits 586 on the plunger 58 in the standby and activated positions respectively of the plunger. Not visible in FIG. 7, but in FIG. 8, is a membrane 538 within the inner tower 530. The membrane 538 is mounted within the inner cylinder or tower 530, which also includes two sealing ribs 532 on the outer surface of inner tower 530.

Plunger 58 mounts to the gondola or base 52 through a snap fit connection in the activated position. Plunger 58 includes an outer housing 584 with two matching male snap fit connections 586 on opposite sides of outer housing 584. The snap fit connection is formed by orifices 536 in two portions 534 of the outer ring 528 of base or gondola 52. Orifices 536a and 536b act as female snap fit connections. The plunger 58 also includes a spike 582 at its distal portion. The upper or proximal portion of plunger 58 includes a flange 588 with two orifices 540, an upper housing 592, and a seat or mount 594 for mounting a valve or other outlet for the port 50. One example is a luer valve 40 with a luer valve cap 42.

The needleless access port cap 56 mounts to the plunger 58. Cap 56 includes an upper portion 562 with longitudinal ribs 564 and tactile nubs 566. Cap 56 also includes a lower portion 568 with two male snap fit connections 570, the male snap fit connections 570 for mating with orifices 540 on flange 588 of plunger 58. The upper portion 562 and lower portion 568 are joined at a very thin, frangible area 572, so that when one desires to use the port 50, the upper portion 562 of the cap 56 can be removed. Orifices 540 in this embodiment are mating female snap-fit connections. Finally, a tamper-evident ring 54 is also mounted atop the base or gondola 52. Tamper-evident ring 54 is molded from two halves 542, 544, the halves connected by a plurality of thin, frangible sections 546. The halves 542, 544 each have an upper portion 548 that matches the outer periphery of flange 588 of plunger 58. Tamper-evident ring 54 is mounted between the base 50 and the flange 588 of plunger 58, such that the frangible sections 546 are mounted squarely between grasping fingers 524 of base 52. The tamper-evident ring 54 may be designed so that the plunger 58 completely splits the two halves 542, 544 apart, allowing them to fall off, or the ring 54 may be designed as shown in this embodiment, in which the plunger 58 does not go down sufficiently far to completely separate the halves 542, 544. The tamper-evident ring 54 halves 542, 544 simply remain in place, making it obvious that someone has at least once activated the plunger 58. It is obvious that the ring 54 has been used because at least at the lower frangible sections 546 are split and the ring 54 itself now is missing or hangs loosely about outer ring 528.

Prior to activation, the snap fit between snap fit connection 586 and orifice 536a provides resistance to inadvertent activation during normal shipping and handling.

When activated, the plunger 58 is depressed and spike 582 pierces membrane 538, allowing fluid communication between a container (not shown) and valve 40. The seal is maintained between inner tower 530 and its ribs 532 against the inside of plunger outer housing 584. When the plunger has been depressed sufficiently far, the male snap-fit connectors 586 engage the second set of female snap-fit connectors 536b in outer ring 528 sections 534. This locks the plunger 58 in place and allows a continued fluid connection between the container (not shown) and the valve 40. The snap fit between the snap fit connection 586 and the second set of snap fit connectors 536b continues to maintain the plunger 58 in the activated position during use, even though the container may be in an upside down position with a portion of the weight of an infusion set (not shown) connected to the luer valve cap 42 acting on the plunger 58.

At the end of the plunging motion, a user then twists off upper cap portion 562, allowing access to luer valve cap 42 and valve 40. If the snap fit connectors 586a and 586b, 536 are designed to be reversible, the plunger may subsequently be raised to break the fluid connection and the cap 42 replaced to maintain a seal. The seal is also maintained by needleless valve 40. Alternatively, the plunger 58 may be left in the lowered position and upper portion 562 of the cap placed atop valve 40 or luer valve cap 42.

During assembly, a sterile connection is achieved for a medication and its port by placing the needleless port on a filled container of medication, and then sterilizing the assembly, usually by autoclaving or by steam sterilization. In a further embodiment the needleless port assembly may be sterilized in preliminary step, but the completed assembly may still be sterilized as a unit. In use, and as depicted in the cross-sectional view of FIG. 8, the sterile connection is maintained between the container (not shown) and the plunger 58 and cap 56 by seal 538 on base 52. A seal is also maintained by ribs 532 between the inner tower 530 of the base 52 and the inner surface of outer housing 584 of the plunger 58. Valve 40 is sealingly attached to the plunger 58. Luer valve cap 42 also preserves the sterility of valve 40. The lower portion 568 of cap 56 also fits tightly over the upper housing 592 of the plunger, and is mounted tightly thereto. It will be recognized that the snap fit connection for holding the plunger in the activated position may be reversible or irreversible. In this embodiment, the snap fit is irreversible, as there is no need to remove the lower portion 568 of the cap once the port 50 is activated by depressing the plunger 58.

To activate the port 50, a user pushes down on cap 56. This forces the halves 542, 544 of the tamper-evident ring 54 to move down and out, away from the cap 56 and plunger 58. Plunger 58 moves downward, and spike 582 penetrates membrane 538, allowing access to a medication within the container. The snap-fit connectors 586 of the plunger 58 latch into the second set of mating connectors 536 and hold the plunger 58 in place with the tamper-evident ring 54 out of the way. The user then twists off upper cap portion 562, breaking the thin frangible area 572. The user removes upper cap portion 562 and connects valve 40 with the desired connection (not shown) for the downstream application. Upper cap portion 562 may be retained for replacement over the luer valve cap 42.

It is desirable to maintain the sterility seals described above. It will be understood that O-rings may be used instead of ribs 532 between the inner tower 530 and the inside of plunger outer housing 584. In addition, cap 56 should fit snugly against luer valve cap 42 and cap lower portion 568 should fit snugly against plunger upper housing 592.

### Turn-to-Activate Embodiment

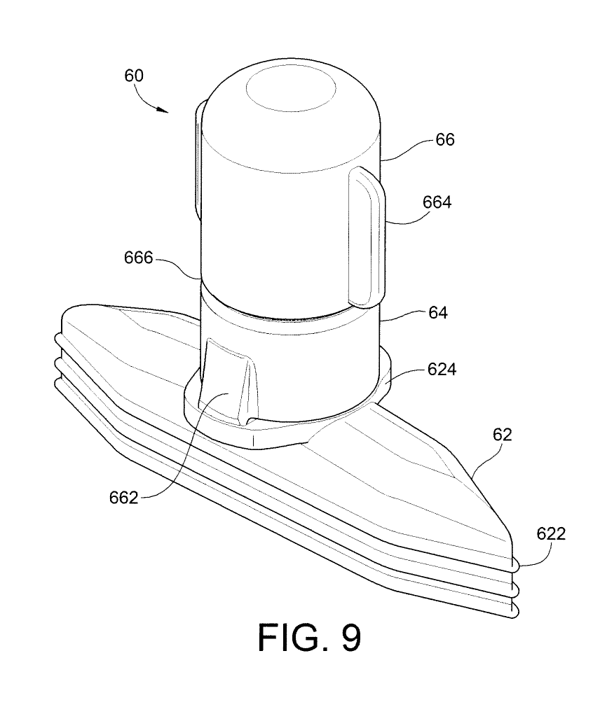

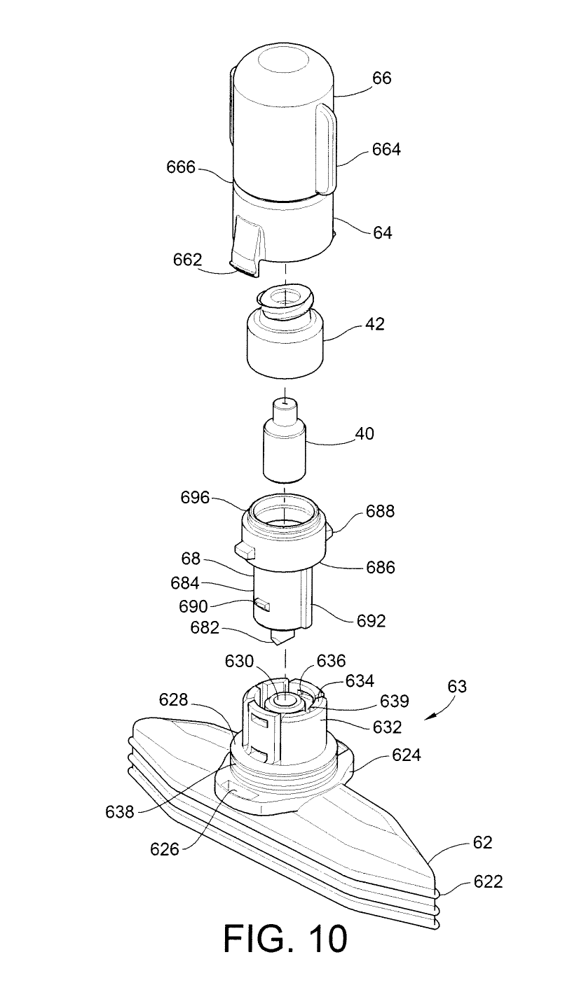

FIGS. 9-11 depict an embodiment in which a user turns a cap to activate a needleless port. Many of the concepts discussed above for FIGS. 6-8 are applied in a similar manner to the embodiment of FIGS. 9-11. Turn-to-activate needleless port 60 includes a base or gondola 62 with sealing ribs 622, a tamper-evident ring 64, a cap 66, a plunger 68, a valve 40 and a luer valve cap 42. The base 62 also includes a mounting flange 624 with two female snap-fit connectors 626 at 180°, an inner tower 630 and an outer tower 632. Mounting flange 624 has a generally cross ovate section, the portion with the snap fit connectors 626 somewhat larger than the remaining portions. Upper portion 628 has a generally circular outer perimeter, with two protruding ribs 638 for sealing against the smooth inside of tamper-evident ring 64. Outer tower 632 is made of six interrupted sections 634, two of which have orifices 636 which act as female snap-fit connectors.

Cap 66 is mounted to tamper-evident ring 64 through a thin frangible section 666. Cap 66 also includes grips 664 for the fingers of a user. Tamper-evident ring 64 mounts to base 62 through two male snap-fit connectors 662, which engage female snap-fits 626 on flange 624 of base 62.

Plunger 68 includes a spike 682 at a lower end of the plunger 68, a lower housing 684 and upper housing 686. Lower housing 684 includes two male snap fit connectors 690 for latching to female snap-fit connectors 636 of the base 62, and also includes a keyway 692 for engaging a matching slot (639) on the inside of outer ring 632. Upper housing 686 has a somewhat larger diameter than the lower housing 684. The upper housing 686 also includes two lugs 688, which act as guides for threads 694 on the inside of cap 66. The upper housing 686 also has a seat or mount 696 on its upper portion for integrally mounting a valve or other fluid communication device. Plunger 68 mounts within cap 66 and hollow tower base 63.

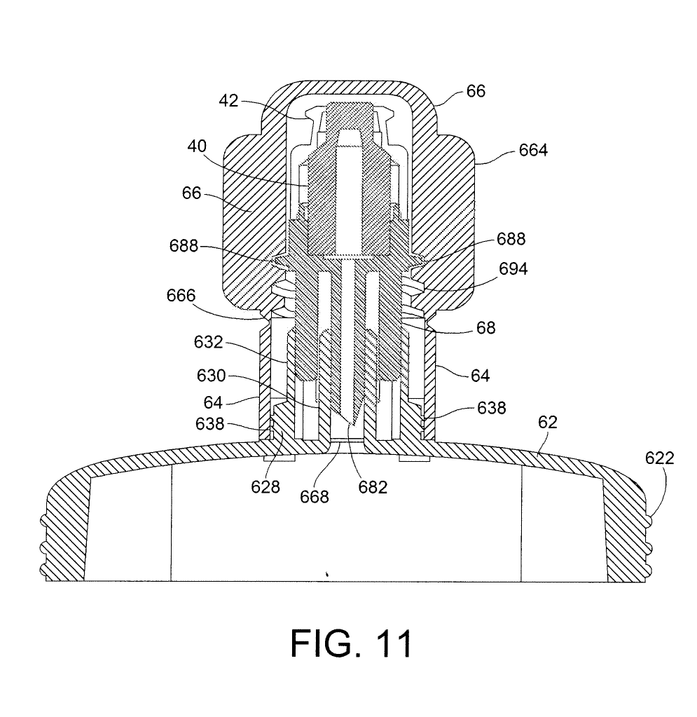

During normal shipment and handling the plunger 68 is maintained in the non-activated position as shown in FIG. 11 by the engagement between the snap fit connectors 690 and the upper set of female snap fit connectors 636.

In use, a user approaches the port 60, grasps the container 10 (not shown) and the cap 66, and twists the cap 360°. Twisting cap 66 breaks the frangible area 666 and disengages the snap fit connector 690 from the upper snap fit connector 63. Rotating the cap 66 causes the plunger 68 with lugs 688 to lower its position as cap internal threads 694 rotate about lugs 688, depressing lugs 688 and plunger 68 until spike 682 pierces membrane 668 of the base 62 and male snap fits 690 of the plunger engage the second set of female snap fits 636 of outer ring 632 portions 634. This retains the plunger in the activated position during normal use of the container. By turning, cap 66 is broken away from frangible area 666 and plunger 68 is in an engaged position, with fluid communication between a bag (not shown) connected to port 60 valve 40.

As better seen in FIG. 11, a first membrane 668 is maintained within inner tower 630 and the plunger 68. An outer seal is also maintained by ribs 638 on the upper portion 628 of mounting flange 624, sealing against the smooth inside of ring 64. During storage or before usage, a seal between ring 64 and the ribs 638 does exist. The user simply grasps the base or container 10 and the cap 66. Using grips 664, the user twists cap 66, thus rotating and lowering the plunger 68, as lugs 688 rotate with within cap threads 694. Cap 66 is turned a sufficient number of turns so that plunger 68 is lowered, as noted, until spike 682 pierces membrane 668, the number of turns also being sufficient so that lugs 688 clear the threads. Lowering plunger 68 causes spike 682 to pierce membrane 668 and enable fluid communication with the medication container (not shown). Twisting also frees the cap 66 by breaking frangible area 666. Cap 66 is then removed by simply lifting it off. The plunger 68 is now locked in place with snap-fit connectors 690 and 636.

It will be recognized that O-rings could be used in place of the ribs 638, the O-rings contained within grooves of the mating surfaces. It is also desirable that ring 64 fits tightly over flange 624 and ribs 638, to insure sterility of the fit. It is also desirable that cap 66 fits tightly over the luer cap 42 and upper housing 686.

As noted, the needleless access port embodiments include one or two valve seats or features used for connections or assembly to valves or other access devices. In one embodiment, such as with needleless valves 40, 42, these valves are luer access valves (LAV), generally available from a variety of manufacturers, such as Halkey-Roberts Corporation of St. Petersburg, Fla., USA. These valves are very useful, because they incorporate a septum and housing which allows repeatable sealed communication with a male luer connector. When a matching connector, such as from a syringe or administration set, is mated with the valve, the septum is penetrated by the luer tip allowing for fluid communication between the syringe or administration set and the interior of the needleless access port. In other embodiments, other connectors or valves may be used. Other needleless valves, including luer access valves may include CLEARLINK® valves by Baxter Healthcare, SmartSite® valves by Cardinal Health, and Ultrasite® valves by B. Braun.

The valves or connectors intended for these application are themselves molded from plastic parts, and may themselves include internal components, such as springs, and so forth. The plastics may include olefins, such as polyethylene, cyclic olefin copolymers (COCs), or other medically-acceptable polymers, such as polyesters, PVC, and polycarbonate (e.g., Lexan®). The polymers and other materials used should be sterilizable, such as by gamma-irradiation or beta-irradiation. The valves or connectors are then assembled to the needleless access port by any of the techniques described above, or any other leak-free, medically-acceptable joining technique.

It has been found that a harder, stiffer material such as polycarbonate is desirable for use as the spike. In addition, other hard, medically-acceptable materials, such as polysulfone may used. The caps for the valve and for the access port may be made of polyethylene or other suitable material. The gondola or base for these embodiments may be made from high density polyethylene (HDPE), which may also be used for the caps and for the tamper-evident features described herein. Any of the materials and devices described herein may be made with an antimicrobial or antibacterial additive or coating, such as those described in U.S. Pat. Appl. Publ. 2007/0003603 and U.S. Pat. appl. Publ. 2008/0027410. These coatings and additives have been shown to reduce infections, particularly catheter related blood stream infections.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claims is:

1. A needleless access port, comprising:
a base with a tower and a sealing area for sealing to a flexible bag;
a sealing membrane within the base;
an access portion moveably assembled to the base, the access portion comprising at least one seat and a spike;
a seal between the spike and the tower, wherein the access portion is configured for mounting to the tower in a first inactivated configuration and in a second activated configuration, and wherein the seal between the tower and the spike is maintained in the first and second configurations and during a transition between the first and second transitions, and wherein the sealing membrane is configured for piercing by the spike when the access portion is moved to the second configuration; and
a cap covering the access portion.

2. The needleless access port according to claim 1, wherein the access portion further comprises at least one valve connected to the at least one seat.

3. The needleless access port according to claim 1, wherein the access portion comprises two seats and at least one luer activated valve.

4. The needless access port according to claim 1, further comprising a sealing sleeve between the tower and the spike.

5. The needleless access port according to claim 1, wherein the access portion and the base are configured with snap fits for the first and second configurations.

6. The needleless access port according to claim 1, wherein the access portion further comprises a tamper-evident ring.

7. The needleless access port according to claim 1, wherein the cap is mounted over the access portion with a frangible connection.

8. The needleless access port according to claim 1, wherein the access portion is configured for activation by pushing or by rotating the cap or the access portion.

9. The needleless access port according to claim 1, further comprising a flexible bag permanently assembled to the access port.

10. The needleless access port according to claim 1, wherein the tower further comprises a notch near an end of the tower away from the base.

11. A needleless access port, comprising:
a base with a sealing area, a prominent tower integrally joined with the base, the tower further comprising a step, and a sealing membrane within the base;
a housing slidably and sealingly mounted to the base, the housing comprising an outer sleeve and further comprising two mounting seats and at least one inner tab for mounting to the tower in a first configuration and a second inner tab for mounting to the tower in a second configuration; and
a spike on an inside of the housing, the spike configured to pierce the sealing membrane when the housing is moved to the second configuration.

12. The needleless access port of claim 11, wherein the first or second inner tab comprises at least one male snap fit.

13. The needleless access port of claim 11, wherein the tower step comprises a female snap fit joint.

14. The needleless access port of claim 11, further comprising a sealing sleeve between the tower and the spike.

15. The needleless access port of claim 11, wherein the housing has a general shape of a Y with a lower portion comprising the outer sleeve and further comprising an inner sleeve, and further comprising a valve mounted to each of the mounting seats.

16. A needleless access port, comprising:
a base housing having a generally cylindrical tower, an area for sealing to a container, and a sealing membrane isolating the tower from the area for sealing;
a top housing comprising an inner spike for slidably mounting to the cylindrical tower, the top housing also comprising an integrally mounted outer sleeve;
at least one connector mounted to the top housing; and
a cap mounted over the top housing,
wherein the top housing is configured for mounting to the base housing in two configurations, a first inactivated configuration and a second activated configuration, and wherein a seal between the top housing and the base housing is maintained in the first and second configurations and during a transition between the first and second configurations.

17. The needleless access port according to claim 16, wherein the top housing further comprises an inner shroud between the spike and the outer shroud, the inner shroud comprising a first snap fit connection and a second snap fit connection.

18. The needleless access port according to claim 16, further comprising a tamper-evident barrier removably secured to the outer shroud or the cap via at least one frangible connection.

19. The needleless access port according to claim 16, wherein the at least one connector is a valve or a luer access valve.

20. The needleless access port according to claim 16, wherein the top housing or the base housing further comprises a flange for mounting the cap.

21. The needleless access port according to claim 16, wherein the base further comprises a mounting sleeve outside the tower, the mounting sleeve formed as a plurality of sections, at least two of the sections further comprising connectors configured for connecting to the top housing outer sleeve.

22. The needleless access port according to claim 16, wherein the top housing and the cap are removable from the base housing and wherein the base housing is configured for accommodating a standard spiking head for connection to the base housing.

23. A needleless access port, comprising:
a plunger with an inner spike, an outer sleeve, and a top mounting seat,
a cap mounted over the plunger; and
a base for sealing to a container, the base comprising an area for sealing to the container, an inner sealing membrane, and an outer surface for sealing to the plunger or the cap, wherein the base comprises a prominent generally cylindrical tower integrally mounted to the base for interfacing with the spike, and wherein the plunger is configured for mounting to the base in a first inactivated position and in a second activated position, and wherein a seal is maintained between the outer surface and the plunger or the cap in the first and second positions and during a transition between the first and second positions.

24. The port according to claim 23, wherein an inner surface of the cap further comprises threads and the plunger further comprises lugs interfacing with the threads, wherein the cap and the plunger are configured so that a user moves the plunger from the first position to the second position by twisting the cap.

25. The port according to claim 23, wherein the plunger comprises a flange for mounting the cap with snap-fit connectors, and wherein the plunger further comprises snap fit connectors for mounting to matching connectors on the base.

26. The port according to claim 23, wherein the base further comprises grasping fingers and wherein the outer surface for sealing is the outside of the tower.

27. The port according to claim 23, wherein the base further comprises an outer mounting ring outside the tower, the mounting ring comprising a plurality of sections, at least two of the sections further comprising connectors for mounting the plunger in the second activated position.

28. A needleless access port, comprising:
a plunger comprising a spike, an outer sleeve, and a mount for a valve;
a cap configured for mounting over the plunger; and
a base comprising an area for sealing to a connector, a membrane seal, a first tower for accepting the spike, a second tower for mounting to the plunger, and an outer surface for sealing to the cap, wherein the plunger and the base are configured for assembly in a first inactive position and for use in a second activated position, wherein the spike is maintained with the first tower in the first and second positions, and wherein a seal is maintained between the cap and the outer surface for sealing to the cap in the first and second positions.

29. The port according to claim 28, wherein the upper portion is threadably joined to the plunger for actuation by rotating the cap with respect to the plunger.

30. The port according to claim 28, wherein the base comprises a flange for mounting the cap.

31. The port according to claim 28, wherein the cap comprises a tamper-evident ring, the cap comprising an upper portion covering the plunger and a lower portion configured for mounting to the base and sealing to the outer surface for sealing to the cap.
